(19) United States
(12) Patent Application Publication
(10) Pub. No.: US 2023/0194301 A1
(43) Pub. Date: Jun. 22, 2023

(54) HIGH FIDELITY ANCHOR POINTS FOR REAL-TIME MAPPING WITH MOBILE DEVICES

(71) Applicant: Univrses AB, Stockholm (SE)

(72) Inventors: Jonathan Nels George Selbie, Stockholm (SE); Alessandro Pieropan, Stockholm (SE)

(21) Appl. No.: 17/644,726

(22) Filed: Dec. 16, 2021

(51) Int. Cl. G01C 21/00

(52) U.S. Cl. CPC G01C 21/3822; G01C 21/3837; G01C 21/3852

(57) ABSTRACT

Methods, systems and computer program products, for map data collection. An anchor point creation mode is activated on a mobile data collection device when the mobile data collection device enters a geographical anchor point creation area. In the anchor point creation mode, the mobile data collection device collects and streams mapping raw data to a remote computing device. A high definition map of the anchor point creation area is created by combining received raw data with mapping data from other data sources. After the map has been created, when a mobile data collection device enters the anchor point creation area, information from the map is used in a data capture mode to refine a determination of a position and/or orientation of the mobile data collection device, and a position and/or orientation of one or more features detected by the mobile data collection device.

### TECHNICAL FIELD

The present invention relates to mapping, and more specifically to collecting data for creation of a digital map of an environment.

### BACKGROUND

Mapping generally refers to the process of creating a high definition (HD) digital map of an environment (also commonly referred to as a “digital twin”), such as a city, by processing data collected with one or multiple sensors. Typically, the data collection process uses a broad set of sensors (optical, radar, sonar, etc.). These can include, for example, one-dimensional (single beam) or two-dimensional (sweeping) laser rangefinders, three-dimensional HD LIDAR, three-dimensional Flash LIDAR, two- or three-dimensional sonar sensors, and one or more two-dimensional cameras. The sensors are typically mounted on a specialized vehicle, and during usual operation a small fleet of such vehicles travel around the different parts of the area to be mapped, e.g., a city, to collect mapping data. The collected data is then processed offline, using powerful computers to generate the HD digital map.

While the data collected by these specialized vehicles and sensors often meet the desired requirements for map creation, this method of data collection requires specialized and expensive equipment, both for the data collection itself and for the subsequent processing of the collected data. Therefore, these conventional techniques of map creation are not very scalable. In addition, it is often difficult to cover larger areas, such as cities, using a small number of vehicles only, and it may therefore often take several weeks or months before one of the vehicles revisits a place or route. As a result, the maps that are generated based on the collected data are often obsolete and may not reflect recent changes to the environment. This, in turn, may have a number of ripple effects on other systems (e.g., navigation applications) that rely on the maps to perform their respective functionalities. Thus, there is a need for improved mapping techniques.

### SUMMARY

According to a first aspect, the invention relates to a map data collection method. An anchor point creation mode is activated on a mobile data collection device in response to the mobile data collection device entering a predefined geographical anchor point creation area. In the anchor point creation mode, the mobile data collection device collects and streams mapping raw data to a remote computing device. A high definition map of the anchor point creation area is created, at least in part by the remote computing device, by combining received raw data with mapping data from other data sources. In response to a mobile data collection device entering the anchor point creation area subsequent to the high definition map being created, information from the high definition map is used in a data capture mode to refine a determination of one or more of: a position of the mobile data collection device, an orientation of the mobile data collection device, a position of one or more features detected by the mobile data collection device, and orientation of one or more features detected by the mobile data collection device.

Various embodiments of the invention can include one or more of the following features. The mapping data from the other data sources include maps, surveys (i.e., data collected by surveyors using surveying equipment), or aerial images. The remote computing device can be a cloud computing device. The mobile data collection device can use GNSS sensors, inertial sensors, magnometers, or camera sensors to determine its position and the position of features detected by the mobile data collection device.

Information from the high definition map can be used to refine previously determined positions of one or more features within the anchor point creation area, or positions of subsequently detected features outside the anchor point creation area. A quality score can be determined for one or more features of interest based on the aggregated mapping data; the quality scores for the one or more features of interest can be evaluate against a threshold value to identify whether any feature of interest meets an anchor point criterion; and in response a feature of interest meeting the anchor point criterion, the feature of interest can be designated as anchor point in the anchor point creation area. The features of interest can include one or more of: street signs, lamp posts, bins, benches, bus stops, and street furniture.

The mode of the mobile data collection device can be switched from the anchor point creation mode to a data capture mode in response to the mobile data collection device exiting the anchor point creation area. The anchor point creation area can be defined by a user. The mobile data collection device can be operated in the data capture mode both inside and outside the anchor point creation area in response to determining that a sufficiently detailed high definition map has been created for the anchor point creation area.

The mobile data collection devices can include a cell phone camera or a camera mounted in a vehicle, and a neural network trained to detect one or more categories of physical features in images captured by the cell phone camera or the mounted camera. The mobile data collection device can further include a radio communication device for communicating collected data to, and receiving data from, a cloud-based platform. The mobile data collection device can be a ground based mobile data collection device. The mobile data collection device can be an autonomous vehicle.

According to a second aspect, the invention relates to a system for map data collection. The system includes a memory and a processor. The memory contains instructions that when executed by the processor causes the processor to perform a method that includes:
in response to a mobile data collection device entering a predefined geographical anchor point creation area, activating an anchor point creation mode on the mobile data collection device, in which anchor point creation mode the mobile data collection device collects and streams mapping raw data to a remote computing device;
creating, at least in part by the remote computing device, a high definition map of the anchor point creation area by combining received raw data with mapping data from other data sources; and
in response to a mobile data collection device entering the anchor point creation area subsequent to the high definition map being created, using information from the high definition map in a data capture mode to refine a determination of one or more of: a position of the mobile data collection device, an orientation of the mobile data collection device, a position of one or more features detected by the mobile data collection device, and orientation of one or more features detected by the mobile data collection device.

According to a third aspect, the invention relates to a computer program product map data collection. The computer program product includes a computer readable storage medium having program instructions embodied therewith, wherein the computer readable storage medium is not a transitory signal per se. The program instructions are executable by a processor to perform a method comprising:
in response to a mobile data collection device entering a predefined geographical anchor point creation area, activating an anchor point creation mode on the mobile data collection device, in which anchor point creation mode the mobile data collection device collects and streams mapping raw data to a remote computing device;
creating, at least in part by the remote computing device, a high definition map of the anchor point creation area by combining received raw data with mapping data from other data sources; and
in response to a mobile data collection device entering the anchor point creation area subsequent to the high definition map being created, using information from the high definition map in a data capture mode to refine a determination of one or more of: a position of the mobile data collection device, an orientation of the mobile data collection device, a position of one or more features detected by the mobile data collection device, and orientation of one or more features detected by the mobile data collection device.

The details of one or more embodiments of the invention are set forth in the accompanying drawings and the description below. Other features and advantages of the invention will be apparent from the description and drawings, and from the claims.

### BRIEF DESCRIPTION OF THE DRAWINGS

FIG. 1 is a flowchart showing a method for determining anchor points, in accordance with one embodiment.

FIG. 2 is a schematic diagram showing a road with a mobile device about to enter an anchor point creation area, in accordance with one embodiment.

FIG. 3 is a schematic diagram showing a road with a mobile device located inside an anchor point creation area, in accordance with one embodiment.

FIG. 4 is a schematic diagram showing a road with a mobile device having exited an anchor point creation area, in accordance with one embodiment.

FIGS. 5A-5B are schematic diagrams showing a mobile device operating in a data collection mode, in accordance with one embodiment.

FIG. 6 is a schematic diagram showing an intersection of two roads with multiple mobile devices collecting anchor point data, in accordance with one embodiment.

Like reference symbols in the various drawings indicate like elements.

### DETAILED DESCRIPTION

As was described above, a goal with the various embodiments of the invention is to reduce the complexity and expense associated with the creation of HD digital maps of various environments, such as a city or parts of a city, in particular with respect to the data collection step. Another goal is to obtain more frequent (and thereby more current) mapping data, compared to existing data collection methods, such that the digital maps are updated more often and have improved accuracy, which also leads to improvements in other applications that use digital maps.

As will be described in detail below, the various embodiments of the invention allow for creation of HD maps, using data collected with a standard sensor setup that can be found on a mobile data collection device (hereinafter referred to as a mobile device), such as a cellular phone or Internet of Things (IoT) device, that is, a camera (although more than a single camera may also be used in the case of a device having several built in cameras), an Inertial Measurement Unit (IMU) and a sensor associated with a Global Navigation Satellite System (e.g., GPS, GLONASS, Baidu, etc.), or various combinations thereof.

The mobile devices can be permanently or temporarily mounted on vehicles that can move, either autonomously or under the control of an operator, on the ground or in the air. Some examples of vehicles include motor vehicles, aircraft, bicycles, drones, or any other manned or unmanned vehicles. The mobile devices are also equipped with - or in some embodiments connected to - a computing device or processor and a data link, such as a cellular 4G or 5G connection. This allows the mobile devices to perform pre-processing of the collected image and positional data prior to sending the data, through the data link, to a cloud-based platform for further processing. The pre-processing can significantly reduce the amount of data that is sent from the mobile devices to the cloud-based platform, thus making the transmission more efficient. The mobile devices can also receive settings and software, such as image processing and/or neural network software, that is tailored to the particular type mobile device (e.g., a connected car vs. a smartphone) or the type of data the mobile device is expected to collect and pre-process, and which allows the mobile devices to operate in different “modes,” as will be described in further detail below.

In order to achieve the enhanced data collection, the various embodiments of the invention automatically create a sparse set of high precision reference points (also referred to herein as “anchor points”) exploiting the sensor setup and computing power of the mobile device intensely during short time periods, which will be referred to below as the mobile device operating in an “anchor point creation mode.” In the anchor point creation mode, in essence, data is streamed from the mobile device to the cloud-based platform, which can be a private cloud-based platform or a public cloud-based platform or a hybrid of the two, where the collected data is processed to generate an HD map and the anchor points. The generated anchor points can subsequently be used by other mobile devices to generate and update maps, while using the mobile devices in a more sustainable way, which will be referred to below as a “data capture mode,” with reduced battery drain and data transmission to the cloud-based platform.

In particular, and as will be described in further detail below, the various embodiments provide mechanisms for automatically triggering the anchor point creation mode on a mobile device, techniques for generating the anchor points based on the sensor data available on the mobile device, and techniques for leveraging of the anchor points to update a generated map using one or more mobile devices operating in the data capture mode. Various embodiments of the invention will now be described by way of example and with reference to the drawings. It should be noted that while the examples below generally refer to a single mobile device, a single road, a single anchor point creation area, etc., this is merely done for ease of understanding the operation of the various embodiments of the invention. In a real life scenario, there will typically be a large number of anchor point creation areas, mobile devices, and the method will generally be a continuous method with few interruptions, if any.

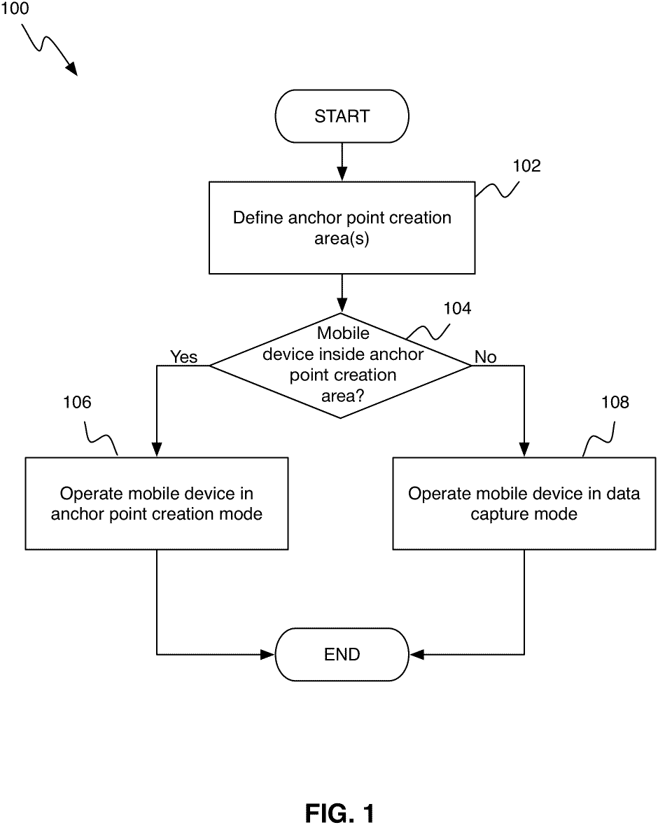

FIG. 1 is a flowchart showing a method 100 for creating and using a HD map in accordance with one embodiment of the invention. As can be seen in FIG. 1, the method starts by a user defining a geographical area, for example, a section of a city for which a HD map is to be created, step 102. This area is referred to as an anchor point creation area. The designation of anchor point creation areas can be done in a semi-automated fashion, in which an expert determines the most suitable location for anchor point creation based on the analysis of historical data, for example data collected over the past year, cross correlation to areas having similar characteristics, user feedback, and engineer experience, just to mention a few factors that may be taken into account.

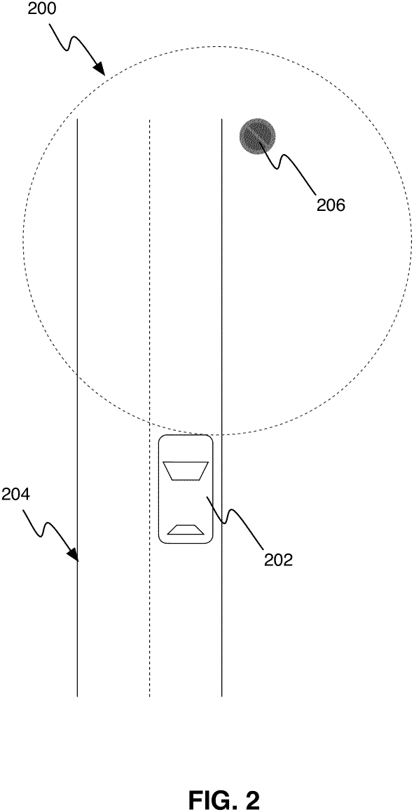

FIG. 2 shows a schematic example of an anchor point creation area 200. The anchor point creation area 200 has the shape of a circle, but as the skilled person realizes, the anchor point creation area 200 may have any arbitrary geometrical shape. Typically, the anchor point creation area is defined by a user, for example, by outlining the anchor point creation area 200 on a digital map of a city or other area of interest. However, it should be realized that various degrees of automation can also be used in defining the anchor point creation area 200. For example, in some embodiments, anchor points can be distributed evenly across a space, such as a city. In other embodiments, anchor points can be created based on metrics of complexity (e.g., number of high buildings, density of buildings, proximity to urban center, etc.). In yet other embodiments, anchor points can be created automatically based on errors in detected feature positions (e.g. high variance between reported position of a feature from different agents), which will be described in further detail below. This indicates poor performance, and may provide information about where an anchor point might provide enhancement. Yet further criteria for creating anchor point areas 200 can be envisioned by those having ordinary skill in the art.

In some embodiments, the anchor point creation area 200 defines a so-called geofencing area. This makes it possible to control various aspects of the mobile devices as they enter the anchor point creation area 200. For example, FIG. 2 shows a mobile device 202 driving down a road 204 that passes through an anchor point creation area 200. As can be seen in FIG. 2, the mobile device 202 is located just outside the anchor point creation area 200. FIG. 2 also shows a road sign 206 located inside the anchor point creation area 200.

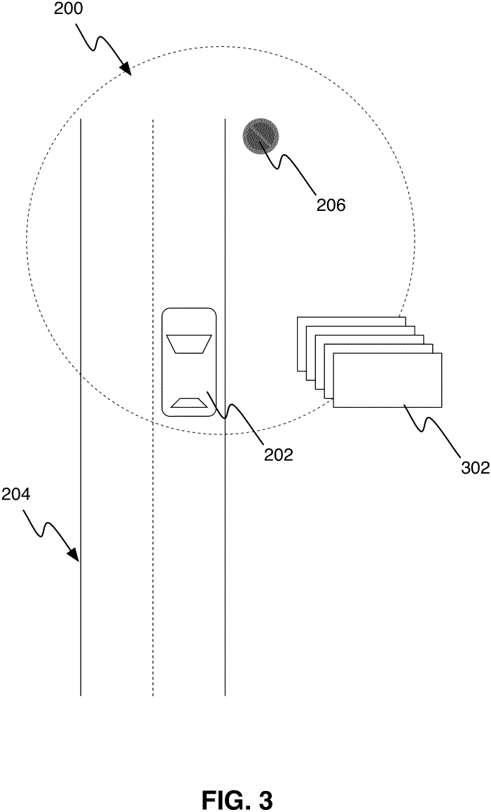

The next step of method 100 involves determining whether a mobile device 202 is located inside the anchor point creation area 200, step 104. This scenario is schematically shown in FIG. 3. The determination can be made, for example, through a simple comparison of the position of the mobile device 202 with respect to the anchor point creation area 200 (i.e., the geofenced area), for example, using GPS technologies as is conventional in the art.

If it is determined in step 104 that the mobile device 202 is inside the anchor point creation area 200, as is illustrated in FIG. 3, the mobile device 202 automatically switches to an anchor point creation mode, step 106. In the anchor point creation mode, the mobile device 202 starts computationally intensive data collection and processing. Images and sensor data are acquired at a higher rate compared to when the mobile device operates in its regular data capture mode, to substantially increase the number of data samples 302 collected and to estimate the location of a feature of interest with higher accuracy than what is possible in the data capture mode. In essence, the collected data is “streamed” to a cloud-based platform where the data is further processed and the HD map is generated, as will be described in further detail below. The data collection typically occurs with a high degree of automation and can involves a range of techniques, such as 3D Positioning, 3D Mapping, 3D Localization, Spatial Deep Learning and Visual-inertial Simultaneous Localization And Mapping (SLAM), Visual Odometry, Object Detection, Tracking, which can be used individually or in various combinations.

It should be noted though that depending on the processing capabilities of the mobile device 202, various levels of pre-processing of the collected data can occur on the mobile device 202, which may reduce the amount of data that is ultimately sent from the mobile device 202 to the cloud-based platform. The high intensity data collection and processing typically comes at a cost in terms of battery drain on the mobile device 202, while processing and sending the collected data to the cloud-based platform. This generally puts some constraints on the size of the anchor point creation areas 200, as it is not desirable for the anchor point creation areas 200 to be so large that a mobile device 202 risks running out of battery power.

As was described above, anchor points are high precision reference points, which can be used as references by mobile devices 202 operating in the data capture mode to improve data collection for new or existing maps. Often, anchor points are street signs, such as the no parking sign 206 located in the anchor point creation area 200, since street signs are distinctive and unlikely to change for an extended period of time. However, the various embodiments of the invention described herein is not limited to street signs 206 only. Essentially, any distinctive feature that has high visibility (i.e., is easily detectable by computer vision during any kind of weather conditions) and is unlikely to change for an extended period of time can be used as an anchor point, such as corners of building, permanent art installations, benches, landscaping features, and so on, just to mention a few examples. The distinctive feature may not necessarily have any “meaning” to a human observer, but may be significant from a computer vision point of view. An anchor point can be assigned a “quality score” that indicates how reliable the anchor point is. In some embodiments, the score may be compared to a reliability threshold value and simply indicate whether the anchor point is reliable or not. In other embodiments, once the quality score is above the minimum reliability threshold, some features may be considered better than others, particularly given such variables as environment (e.g. weather, lighting, time of day) and orientation/trajectory (e.g. approaching the anchor point from a particular direction).

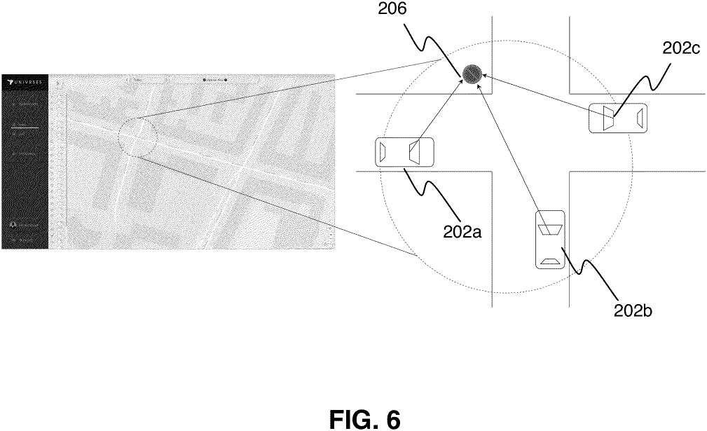

In some embodiments, in order to further improve the data collection, data from multiple mobile devices 202 operating in the data anchor point creation mode can be combined, as shown in FIG. 6. In the example illustrated in FIG. 6, the same road sign 206 is detected by three mobile devices 202a, 202b, and 202c, all being located inside the anchor point creation area 200 and all operating in the anchor point creation mode. The road sign 206 is detected by three different mobile devices and from three different directions, each of which reports the location of the road sign 206 to the cloud-based platform. This allows the cloud-based platform to combine the information received from the mobile devices 202a, 202b, 202c and determine the location of the road sign 206 with high accuracy, and as a result, the road sign 206 is considered a reliable anchor point upon which other mobile devices can rely for purposes of better location determination. It should be noted that the three mobile devices 202a, 202b, 202c do not need to detect the road sign 206 simultaneously, although it may appear so in FIG. 6. In fact, it may even be advantageous to have the three mobile devices 202a, 202b, 202c detect the road sign 206 under different conditions (e.g., with respect to light, weather, etc.).

In some embodiments, when a sufficient number of anchor points 206 of acceptable quality have been collected in an anchor point creation area 200, the mobile devices 202 entering the anchor point creation area 200 continue to operate in their data collection mode, rather than activating their anchor point mode. The criteria for what is considered a sufficient number of anchor points 206 of acceptable quality can be determined by users of the method, and are generally based on a number of different conditions that are specific to the particular situation at hand. A few examples include the number of passes of mobile devices 202 through the anchor point creation area 200, the number of passes of mobile devices 202 through the anchor point creation area 200 from different directions, variance between measurements of anchor point positions and orientations, and comparison with other known high accuracy but out-of-date sources (verification).

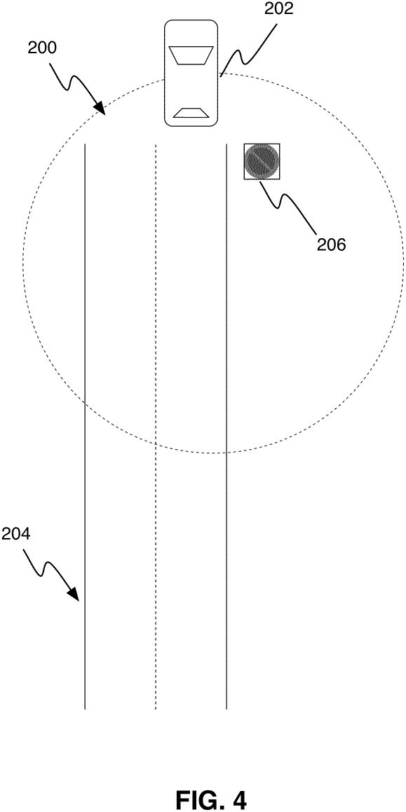

Returning now to FIG. 1, if a mobile device 202 is not inside an anchor point creation area 200, either because the mobile device 202 never entered the anchor point creation area 200, or because it left the anchor point creation area 200, as shown in FIG. 4, the mobile device 202 will operate in the data capture mode, step 108. The switchover from the anchor point creation mode to the data capture mode can occur automatically as the mobile device 202 exits the geofenced anchor point creation area 200.

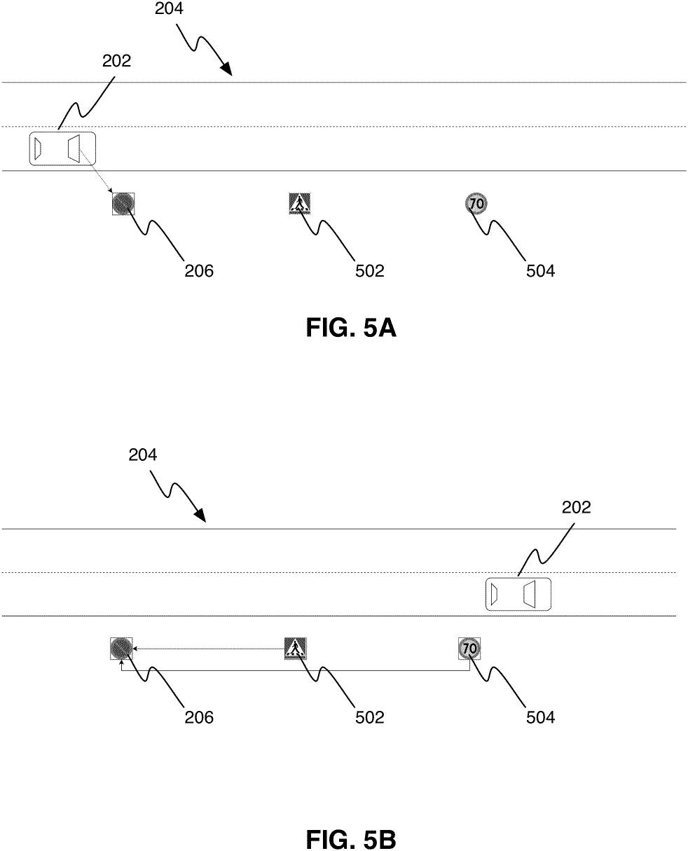

FIGS. 5A and 5B show conceptually how a mobile device 202 travels along a road 204 and operates in the data capture mode. The mobile device 202 can be a mobile device that was previously operating in the anchor point creation mode, as described above, or a completely different mobile device 202. Regardless, the same principles apply. As can be seen in FIG. 5A, a mobile device 202 travels along a road 204 and localizes a previously determined anchor point 206. The mobile device 202 can determine an error between its estimated position of the anchor point 206 and the anchor point’s actual position, as determined when the anchor point 206 was created. This error is typically caused by sensor biases and noise in the mobile device 202, but may also be caused by other factors such as lighting (e.g. low sun, reflections for surroundings, etc.) or vibration (e.g., a mounting vehicle may vibrate due to engine or poor road conditions). The mobile device 202 can use the anchor point 206 to correct its own estimated location. As the mobile device 202 travels along the road 204 and detects new features (e.g., road signs 502, 504) that are not present in a map of the area, the positions of these new features 502, 504 can then be determined with higher accuracy (i.e., with respect to the anchor point 206), as schematically illustrated in FIG. 5B compared to what would be possible if the mobile device’s location, as determined by itself, had not been corrected. In some embodiments, the approximate positions of the new features 502, 504 are determined using conventional methods, e.g., GPS, , and then the positions are refined using the precise location of the anchor point 206. All the detected new features 502, 504 are sent to the cloud-based platform, which updates HD map to include the new features 502, 504.

It should be further noted that the anchor points 206 can also be used to improve the determination of the mobile devices 202 location and orientation, outside the anchor point creation area 200. For example, in a scenario where there is a small error in the position and/or orientation (i.e., roll, pitch and yaw (Euler angles) or some quaternion relative to some datum) of a mobile device 202, that error might increase as the mobile device 202 travels away from the point where the positional determination error occurred. As a result, the eventual position of the mobile device 202, as determined by the mobile device 202 itself, may be significantly different from its actual position, and any measurements of newly detected features 502, 504, along the way will therefore also be assigned erroneous locations. Having reliable anchor points on the other hand can prevent, or at least significantly reduce, these types of errors, since the anchor points allow the actual location of the mobile device 202 to be compared to the measured location by the mobile device 202 and make any necessary corrections. As was discussed above, a better location determination of the mobile device 202 in the vicinity of an anchor point results in a better location determination of the mobile device 202 (and thus discovered new features) as the mobile device 202 moves away from the anchor point and the general anchor point creation area.

At some point, however, the error in location of the mobile device’s own estimated position vs. its actual position may become large enough to warrant the creation of another anchor point creation area 200. The criteria for determining whether such a need exists and should be acted on will depend on the particular situation at hand and can be readily determined by a person having ordinary skill in the art. Various measurements can also help in making this determination, such as the time that has passed since the last “recalibration” of the mobile device’s position, or the estimated error received from satellites involved in the global positioning measurements, etc. Thus, a city, for example, may have a number of discrete anchor point creation areas, and there may be a larger number of anchor points in areas of the city that have worse satellite coverage, such as areas with lots of tall buildings or a large number of trees, etc.

Thus, in contrast to existing solutions, the various embodiments of the present invention do not rely on any pre-existing map or pre-existing anchors that have been created using specialized vehicles with an expensive sensor setup. Instead, the anchor points are generated in a semi- or fully automated process, in which the only potential manual input is the definition of one or more anchor point creation areas 200, e.g., in a city where the anchor point creation should be performed. As a result, a more current and accurate HD map can be created.

As was noted above, having these anchor points makes it possible to generate a very accurate HD map, of a city or individual areas thereof, which can be used for a wide range of purposes. The HD map can be generated, for example, by using a conventional geographical map in an electronic format, similar to maps that are used by various mapping service providers, such as Google Maps, Apple Maps, etc., storing feature datasets in a geo-referenced data type format (e.g., the GeoJson open standard format) and then adding the anchor points and other features collected by the mobile devices to this map. In some implementations, various types of third party data, such as information relating to weather, road regulations (e.g., speed limits) for various road segments, inventory of assets (e.g., traffic signs) beside the road, temporary changes (e.g., roadworks), maps of parking spots, etc., can also be added to the map, if desired.

The HD map can then be displayed to a user in a web-based user interface on a display, or in a standalone application that is implemented locally on a computing device. Typically, the graphical user interface (GUI) for the map contains a number of controls allowing the user to zoom in or out, pan, etc., as well as controls for selecting what “layers” should be displayed on the map. For example, the user may choose to display information relating to congestion, types of roads, speed limits, road works, parking availability, etc. The user can then examine this information and provide instructions to various systems, devices, or people to take actions to alleviate any detected problems.

Certain components or all components may be implemented as software executed by a digital signal processor or microprocessor, or be implemented as hardware or as an application-specific integrated circuit. Such software may be distributed on computer readable media, which may comprise computer storage media (or non-transitory media) and communication media (or transitory media). As is well known to a person skilled in the art, the term computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments described above have used image sensors, such as cameras, it should be noted that there may be implementations in which other types of sensors can be used, such as optical sensors, infrared imaging sensors, ultraviolet imaging sensor, Light Detection and Ranging (LIDAR) sensors, Synthetic Aperture Radar (SAR) sensors, electromagnetic (EM) and/or acoustic sensors or any other sensor capable of producing one or more images of physical features in a physical environment.

Further, it should be noted that while the invention has been described above by way of example and with respect to embodiments configured to be used in a city or part of a city, other, similar embodiments can be used in different environments, such as a warehouse, a mine, etc. Essentially any environment for which a digital twin can be created and used for navigation purposes is considered to fall within the scope of the appended claims.

It will be appreciated that a person skilled in the art can modify the above-described embodiments in many ways and still use the advantages of the invention as shown in the embodiments above. Thus, the invention should not be limited to the described embodiments but should only be defined by the appended claims. Additionally, as the skilled person understands, the shown embodiments may be combined.

What is claimed is:

1. A map data collection method, comprising:
in response to a mobile data collection device entering a predefined geographical anchor point creation area, activating an anchor point creation mode on the mobile data collection device, in which anchor point creation mode the mobile data collection device collects and streams mapping raw data to a remote computing device;
creating, at least in part by the remote computing device, a high definition map of the anchor point creation area by combining received raw data with mapping data from other data sources; and
in response to a mobile data collection device entering the anchor point creation area subsequent to the high definition map being created, using information from the high definition map in a data capture mode to refine a determination of one or more of: a position of the mobile data collection device, an orientation of the mobile data collection device, a position of one or more features detected by the mobile data collection device, and orientation of one or more features detected by the mobile data collection device.

2. The method of claim 1, wherein the mapping data from other data sources include one or more of: maps, surveys, and aerial images.

3. The method of claim 1, wherein the remote computing device is a cloud computing device.

4. The method of claim 1, wherein the mobile data collection device uses one or more of: GNSS sensors, inertial sensors, magnometers, and camera sensors to determine its position and the position of features detected by the mobile data collection device.

5. The method of claim 1, further comprising:
using information from the high definition map to refine one or more of: previously determined positions of one or more features within the anchor point creation area, and positions of subsequently detected features outside the anchor point creation area.

6. The method of claim 1, further comprising:
determining a quality score for one or more features of interest based on aggregated mapping data;
evaluating the quality score for the one or more features of interest against a threshold value to identify whether any feature of interest meets an anchor point criterion; and
in response a feature of interest meeting the anchor point criterion, designating the feature of interest as anchor point in the anchor point creation area.

7. The method of claim 6, wherein the features of interest include one or more of: street signs, lamp posts, bins, benches, bus stops, and street furniture.

8. The method of claim 1, further comprising:
in response to the mobile data collection device exiting the anchor point creation area, switching the mode of the mobile data collection device from the anchor point creation mode to a data capture mode.

9. The method of claim 1, wherein the anchor point creation area is defined by a user.

10. The method of claim 1, further comprising:
in response to determining that a sufficiently detailed high definition map has been created for the anchor point creation area, operating the mobile data collection device in the data capture mode both inside and outside the anchor point creation area.

11. The method of claim 1, wherein the mobile data collection devices include one or more of: a cell phone camera or a camera mounted in a vehicle, and a neural network trained to detect one or more categories of physical features in images captured by the cell phone camera or the mounted camera.

12. The method of claim 1, wherein the mobile data collection device further includes a radio communication device for communicating collected data to, and receiving data from, a cloud-based platform.

13. The method of claim 1, wherein the mobile data collection device is a ground based mobile data collection device.

14. The method of claim 1, wherein the mobile data collection device is an autonomous vehicle.

15. A system for map data collection, comprising:
a memory; and
a processor,
wherein the memory contains instructions that when executed by the processor causes the processor to perform a method that includes:
in response to a mobile data collection device entering a predefined geographical anchor point creation area, activating an anchor point creation mode on the mobile data collection device, in which anchor point creation mode the mobile data collection device collects and streams mapping raw data to a remote computing device;
creating, at least in part by the remote computing device, a high definition map of the anchor point creation area by combining received raw data with mapping data from other data sources; and
in response to a mobile data collection device entering the anchor point creation area subsequent to the high definition map being created, using information from the high definition map in a data capture mode to refine a determination of one or more of: a position of the mobile data collection device, an orientation of the mobile data collection device, a position of one or more features detected by the mobile data collection device, and orientation of one or more features detected by the mobile data collection device.

16. A computer program product map data collection, the computer program product comprising a computer readable storage medium having program instructions embodied therewith, wherein the computer readable storage medium is not a transitory signal per se, the program instructions being executable by a processor to perform a method comprising:
in response to a mobile data collection device entering a predefined geographical anchor point creation area, activating an anchor point creation mode on the mobile data collection device, in which anchor point creation mode the mobile data collection device collects and streams mapping raw data to a remote computing device;
creating, at least in part by the remote computing device, a high definition map of the anchor point creation area by combining received raw data with mapping data from other data sources; and
in response to a mobile data collection device entering the anchor point creation area subsequent to the high definition map being created, using information from the high definition map in a data capture mode to refine a determination of one or more of: a position of the mobile data collection device, an orientation of the mobile data collection device, a position of one or more features detected by the mobile data collection device, and orientation of one or more features detected by the mobile data collection device.
